(19) United States
(12) Patent Application Publication
(10) Pub. No.: US 2026/0299559 A1
(43) Pub. Date: Oct. 1, 2026

(54) METHOD, SYSTEM, AND DEVICE FOR MOTOR CONTROL

(71) Applicant: STMicroelectronics International N.V., Geneva (CH)

(72) Inventors: Andrea ANFUSO, Tremestieri Etneo (IT); Carmelo Marcello PALANO, Acicatena (IT); Claudio IOZZIA, Modica (IT)

(73) Assignee: STMicroelectronics International N.V., Geneva (CH)

(21) Appl. No.: 19/097,382

(22) Filed: Apr. 1, 2025

(51) Int. Cl. G05B 19/418

(52) U.S. Cl. CPC G05B 19/41835; G05B 19/4187; G05B 2219/32102; G05B 2219/32128; G05B 2219/32129

(57) ABSTRACT

A motor system having a configurable component is designed and configured using a graphical user interface (GUI). A first type of motor control system (MCS) component is selected via the GUI from a list of types of MCS components. A component of the selected type is selected from a list of components of the selected type via the GUI. A MCS component of a second type is selected from a list of MCS components of the second type via the GUI. A representation of a physical coupling between the selected MCS component of the first type and the selected MCS component of the second type is presented via the GUI. Configuration settings and content for a configurable MCS component are generated based on the selected MCS component of the first type and the selected MCS component of the second type.

### BACKGROUND

### Technical Field

The present disclosure generally relates to configuring motor control systems, such as of the type often used industrial motor, robotic, power tool and automotive servo motor applications.

### Description of the Related Art

Motor control system design applications include tools to simplify and expedite the complex process of designing motor control systems, and writing firmware for motor control applications using specific hardware. Some motor control system design applications include graphical user interfaces to assist with the selection and configuration of components of a motor control system.

### BRIEF SUMMARY

In an embodiment, a method of generating content for a configurable motor control system is performed by a processing device. The method includes presenting, via a graphical user interface, a first list of types of motor control system components, the first list of types of motor control system components including motors and a plurality of system board types. A first selection of a first type of motor control system component from the first list of types of motor control system components is received via the graphical user interface. In response to the first selection of a first type of motor control system component from the first list of types of motor control system components, a second list of motor control system components of the first type is presented via the graphical user interface, and a second selection of a motor control system component of the first type from the second list of motor control system components of the first type is received via the graphical user interface. In response to the second selection of the motor control system component of the first type, a third list of motor control system components of a second type different from the first type is presented via the graphical user interface, and a third selection of a motor control system component of the second type from the third list of motor control system components of the second type is received via the graphical user interface. In response to the third selection of the motor control system component of the second type, a representation of a physical coupling between the selected motor control system component of the first type and the selected motor control system component of the second type is presented via the graphical user interface. Configuration settings for a configurable motor control system component are generated based on the selected motor control system component of the first type and the selected motor control system component of the second type, content for the configurable motor control system component is generated based on the configuration settings, and the generated content is provided to the configurable motor control system component.

In an embodiment, contents of a non-transitory computer-readable medium configure a processing device to perform a method of generating content for a configurable motor control system. The method includes presenting, via a graphical user interface, a first list of types of motor control system components, the first list of types of motor control system components including motors and a plurality of system board types. A first selection of a first type of motor control system component from the first list of types of motor control system components is received via the graphical user interface. In response to the first selection of a first type of motor control system component from the first list of types of motor control system components, a second list of motor control system components of the first type is presented via the graphical user interface, and a second selection of a motor control system component of the first type from the second list of motor control system components of the first type is received via the graphical user interface. In response to the second selection of the motor control system component of the first type, a third list of motor control system components of a second type different from the first type is presented via the graphical user interface, and a third selection of a motor control system component of the second type from the third list of motor control system components of the second type is received via the graphical user interface. In response to the third selection of the motor control system component of the second type, a representation of a physical coupling between the selected motor control system component of the first type and the selected motor control system component of the second type is presented via the graphical user interface. Configuration settings for a configurable motor control system component are generated based on the selected motor control system component of the first type and the selected motor control system component of the second type, content for the configurable motor control system component is generated based on the configuration settings, and the generated content is provided to the configurable motor control system component.

In an embodiment, a computing device includes a display device, a memory, which, in operation, stores computer instructions, and at least one processor, which, in operation, executes the computer instructions to generate and provide content to a configurable motor control system component. The generating the content includes presenting, via a graphical user interface, a first list of types of motor control system components, the first list of types of motor control system components including motors and a plurality of system board types. A first selection of a first type of motor control system component from the first list of types of motor control system components is received via the graphical user interface. In response to the first selection of a first type of motor control system component from the first list of types of motor control system components, a second list of motor control system components of the first type is presented via the graphical user interface, and a second selection of a motor control system component of the first type from the second list of motor control system components of the first type is received via the graphical user interface. In response to the second selection of the motor control system component of the first type, a third list of motor control system components of a second type different from the first type is presented via the graphical user interface, and a third selection of a motor control system component of the second type from the third list of motor control system components of the second type is received via the graphical user interface. In response to the third selection of the motor control system component of the second type, a representation of a physical coupling between the selected motor control system component of the first type and the selected motor control system component of the second type is presented via the graphical user interface. Configuration settings for a configurable motor control system component are generated based on the selected motor control system component of the first type and the selected motor control system component of the second type, content for the configurable motor control system component is generated based on the configuration settings. The generated content is provided to the configurable motor control system component.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views, unless the context indicates otherwise. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 is a block diagram showing an example computing environment for implementing embodiments described herein.

FIG. 2 is a block diagram showing an example control board of a configurable motor control system according to an embodiment.

FIG. 3 is a block diagram showing an example adaptor board of a configurable motor control system according to an embodiment.

FIG. 4 is a block diagram showing an example power board of a configurable motor control system according to an embodiment.

FIG. 5 is a block diagram showing an example motor or motor board of a configurable motor control system according to an embodiment.

FIG. 6 is a block diagram showing an example conceptual structure for storing aspects utilized in generating content in accordance with embodiments described herein.

FIG. 7 shows a logical flow diagram of a process for generating content for a configurable motor control system in accordance with embodiments described herein.

FIG. 8 shows a logical flow diagram of a process for updating a graphical user interface during the content generation process in accordance with embodiments described herein.

FIG. 9 is an illustrative example of a graphical user interface to enable a user to select one or more component types for a project in accordance with embodiments described herein.

FIGS. 10 and 11 are illustrative examples of a graphical user interface to enable a user to select a particular component of a selected component type for a project in accordance with embodiments described herein.

FIGS. 12A to 12C are illustrative examples of a graphical user interface to enable a user to select a particular component of a second selected component type for a project in accordance with embodiments described herein.

FIGS. 13A to 13D are illustrative examples of a graphical user interface to enable a user to select components of different component types for a project in accordance with embodiments described herein.

FIG. 14 is an example flow diagram of a process of configuring a motor control system in accordance with embodiments described herein.

FIG. 15 is a conceptual diagram illustrating example motor control systems that can be configured using a process to generate content for a configurable motor control system.

### DETAILED DESCRIPTION

In the following description, along with the accompanying drawings, certain details are set forth in order to provide a thorough understanding of various embodiments of devices, systems, methods, and articles. One of skill in the art, however, will understand that other embodiments can be practiced without these details. In other instances, well-known structures and methods associated with, for example, circuits, such as transistors, multipliers, adders, dividers, comparators, integrated circuits, logic gates, finite state machines, accelerometers, gyroscopes, magnetic field sensors, memories, bus systems, power converters, etc., have not been shown or described in detail in some figures to avoid unnecessarily obscuring descriptions of the embodiments. Moreover, well-known structures or components that are associated with the environment of the present disclosure, including but not limited to the communication systems and networks, have not been shown or described in order to avoid unnecessarily obscuring descriptions of the embodiments.

Unless the context indicates otherwise, throughout the specification and claims that follow, the word “comprise” and variations thereof, such as “comprising,” and “comprises,” are to be construed in an open, inclusive sense, that is, as “including, but not limited to.”

Throughout the specification, claims, and drawings, the following terms take the meaning explicitly associated herein, unless the context indicates otherwise. The term “herein” refers to the specification, claims, and drawings associated with the current application. The phrases “in one embodiment,” “in another embodiment,” “in various embodiments,” “in some embodiments,” “in other embodiments,” and other variations thereof, refer to one or more features, structures, functions, limitations, or characteristics of the present disclosure, and are not limited to the same or different embodiments unless the context indicates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive, and allows for being based on additional features, functions, aspects, or limitations not described, unless the context indicates otherwise. In addition, throughout the specification, the meaning of “a,” “an,” and “the” include singular and plural references. Furthermore, the particular features, structures, or characteristics can be combined in any suitable manner in one or more embodiments to obtain further embodiments.

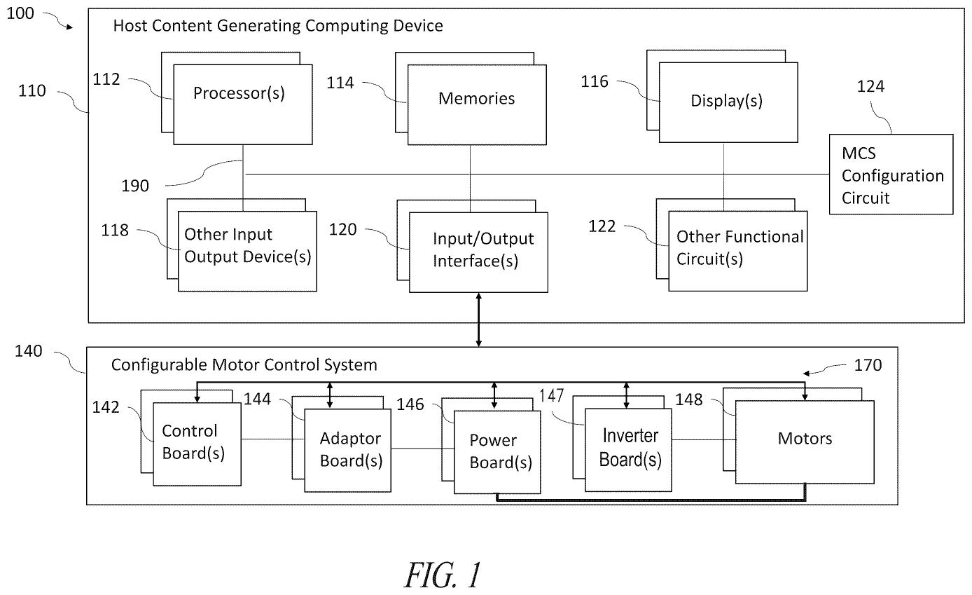

FIG. 1 is a functional block diagram showing an example computing environment 100 for implementing embodiments described herein. Environment 100 includes a host content generating computing device 110 and a configurable motor control system (MCS) 140.

The host content generating computing device 110 as illustrated includes one or more processors 112, one or more memories 114, one or more displays 116, one or more other user input/output devices 118, one or more interfaces 120, one or more other functional circuits 122, and a bus system 190. The host content generating computing device 110 is configured to employ embodiments described herein to generate a graphical user interface to present to a user, to enable the user to select and configure components, and to generate content for configuring the software or hardware, or both, of configurable components of the configurable motor control system 140.

Processor 112 can include one or more processing cores that are configured to execute computer instructions to employ embodiments described herein. While the host content generating computing device 110 can be implemented as a standalone system, embodiments are not so limited. For example, distributed embodiments can be employed (e.g., an application executing on a local host content generating computing device can communicate with a remote server, which can provide all or part of the functionality of the host content generating computing device 110).

Memory 114 can include one or more various types of non-volatile and/or volatile storage technologies. Examples of memory 114 can include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 114 can be utilized to store information, including computer-readable instructions that are utilized by processor 112 or other components, such as the MCS configuration module 124, to perform actions, including embodiments described herein.

Input/output interface 120 can include one or more other data input or output interfaces. For example, the input/output interface 120 can include or provide data to a display device 116, which can be used to present the graphical user interface to the user. The input/output interface 120 can accept input from the user to select and configure or customize components, for example, via the display 116, via one or more of the other input/output devices 118, or various combinations thereof, as described herein. The one or more other input devices 118 can include keyboards, mice, etc., and various combinations thereof. Moreover, the input/output interface 120 is configured to provide content generated as described herein to the configurable MCS 140.

The other functional circuits 122 can include antennas, power supplies, one or more built-in self-test (BIST) circuits, etc., and various combinations thereof. The bus system 190 can include one or more data, address, power, interrupt, and/or control buses coupled to the various components of the host content generating computing device 110. Proprietary bus systems and interfaces can be employed.

The MCS 140, as illustrated, includes one or more motor control boards or circuits 142, one or more adaptor boards or circuits 144, one or more power boards or circuits 146, one or more inverter boards or circuits 147, and one or more motors 148. As discussed in more detail below, the control boards 142, the adaptor boards 144, the power boards 146, the inverter boards 147, and the motors 148 can be coupled together via various bus systems, cables, connectors, and interfaces. As illustrated, a bus system 170 couples the various components of the MCS 140 together. In some embodiments, an MCS 140 can be assembled as a set of one or more circuits (e.g., one or more motor control circuits 142, one or more adaptor circuits 144, one or more power circuits 146, one or more inverter circuits 147), and one or more motors 148, or various combinations thereof, coupled together on one or more configurable MCS boards.

Conventionally, to effectively design and configure a MCS (e.g., MCS 140), designers needed to possess extensive knowledge in the motor control field to ensure the selected components comply with various constraints on operation, configuration and physical couplings of the components of the MCS for a particular application. The complexity and vast number of possible component combinations and configurations make it challenging to provide a straightforward method for creating and configuring a functional MCS. Conventional motor control design applications fall short in simplifying the project creation phase due to poorly designed or absent guidance systems, an excessive number of steps required, etc., often limiting the available configurations to a limited number of predefined sets of hardware configurations. Thus, it is frequently difficult to create customized projects using current motor control design applications. In addition, conventional motor control design applications do not present a designer with a global view of the project as the project is being designed and revised, which means the consequences of the individual configuration interactions are not always clear to the designer as configuration choices and changes are made to an MCS configuration.

To facilitate simplifying the MCS creation and configuration process, and to facilitate allowing designers with a limited knowledge in the field to easily create well-designed working MCS systems for project applications, the host content generating computing device 110 includes a MCS configuration module or circuit 124. As discussed in more detail below, the MCS configuration module 124, in operation, controls presenting, via a graphical user interface, component, coupling, and configuration options for a MCS, generating content for the configurable MCS based on the selected options, and providing the generated content to the components of the configurable MCS.

The MCS configuration module 124 can facilitate simplifying the component selection process, maximizing the designer's freedom of choice, guiding the designer on the selection and configuration process by showing board compatibilities in a clear way, showing a project status under a single graphical user interface view, and highlighting the consequences of each interaction during the design and configuration process. Implementations corresponding to the real-world physical process of assembling the boards can be employed to make graphical user interface feel familiar to the user/designer.

Embodiments of the system 100 of FIG. 1 can include fewer components than illustrated, can include more components than illustrated, and can combine or separate components in various manners. For example, the MCS 140 can include one or more programmable interfaces to receive content generated by the host computing device 110. Individual components of the MCS 140 can include programmable interfaces to receive content generated by the host content generating computing device 110. In another example, a MCS can include a control board 142, a power board 146 and a motor 148 coupled together, without including an adaptor board 144. In another example, the display 116 can be part of the input/output interface 120 in some embodiments (e.g., a touchscreen can be employed to display options and to receive user input). In another example, a configurable MCS can include additional components, such as optional actuators, sensors, valves, etc., which can be separate from or integrated into another component of the configurable MCS (e.g., a motor can include one or more sensors, etc.).

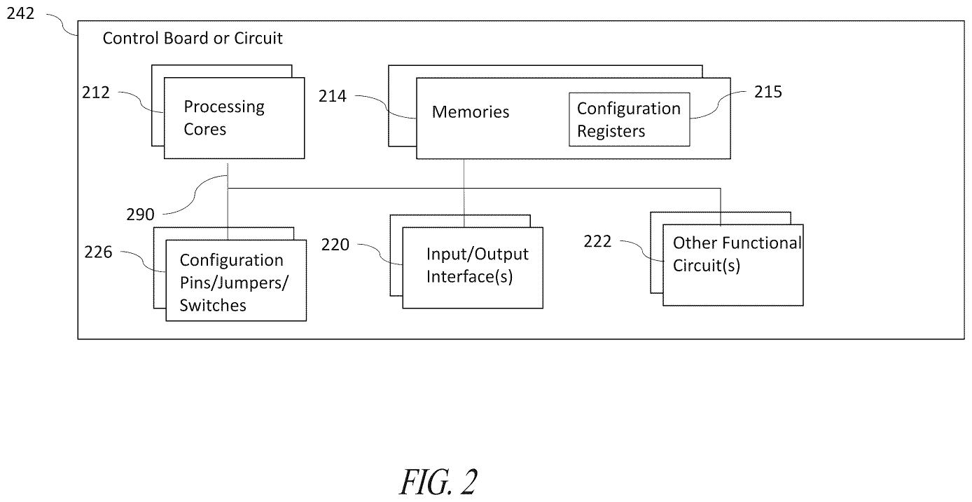

FIG. 2 is a functional block diagram of an embodiment of a control board or circuit 242 that can be employed, for example, as a control board or circuit 142 of the MCS system 140 of FIG. 1. The control board 212 as illustrated has one or more processing cores 212, one or more memories 214, one or more input/output interfaces 220, one or more other functional circuits 222, a bus system 290, and one or more configuration pins/jumpers/switches 226. The control board or circuit 242 can be implemented as a system on a chip (SoC).

The processing core(s) 212 can implement or include a state machine, a microprocessor, a programmable logic circuit, discrete circuitry, a proportional integral (PI) controller, a proportional integral derivative (PID) controller, logic gates, registers, etc., and various combinations thereof. In operation, the processing core(s) 212 can control operation of a MCS using configuration content generated by a host content generating computing device, such as the host content generating computing device 110 of FIG. 1.

The one or more memories 214 can be volatile or non-volatile memories, which can store, for example, all or part of instructions and data related to applications and operations performed by an MCS, such as the MCS 140 of FIG. 1. As illustrated, the memory 214 includes one or more configuration registers 215, which can store thresholds, control flags, pointers, and other configuration information related to the configuration or operation of an MCS.

The input output interfaces 220 can transmit and receive control signals and information between the control board 242 and other components of the MCS (e.g., adaptor boards, power boards, motors, sensors, etc.) to control the operation of a configured MCS. The input output interfaces 220 also can transmit information (e.g., settings of configuration pins/jumpers and switches 226, values stored in configuration registers 215) to a host content generating computing device (see host computing device 110 of FIG. 1) for use in generating content for the MCS, to a host controller for use in controlling a configured MCS, etc., and various combinations thereof. The input output interfaces 220 also can receive information (e.g., content generated for a MCS by a host controller, such as executable code, values to be stored in configuration registers 215, settings to be applied to configuration switches, etc.) from a host content generating computing device (see host computing device 110 of FIG. 1) for use in configuring or controlling components of a configured MCS.

The other functional circuits 222 can include antennas, power supplies, one or more built-in self-test (BIST) circuits, internal peripherals, etc., and various combinations thereof. The internal peripherals can include a universal asynchronous receiver-transmitter (UART), a timer, an analog-to-digital (A/D) converter, a digital to analog (D/A) converter, an inter integrated circuit (IC2) interface, a serial peripheral (SPI) interface, etc. The bus system 290 can include one or more data, address, power, interrupt, and/or control buses coupled to the various components of the host content generating computing device 110. Proprietary bus systems and interfaces can be employed.

The configuration pins/jumpers/switches 226 store configuration information which may be sampled or read during configuration of a configurable motor control system (e.g., read by a host content generating computing device 110), read at boot time as part of a process of configuring the MCS, or at run-time to control the operation of the MCS, or various combinations thereof.

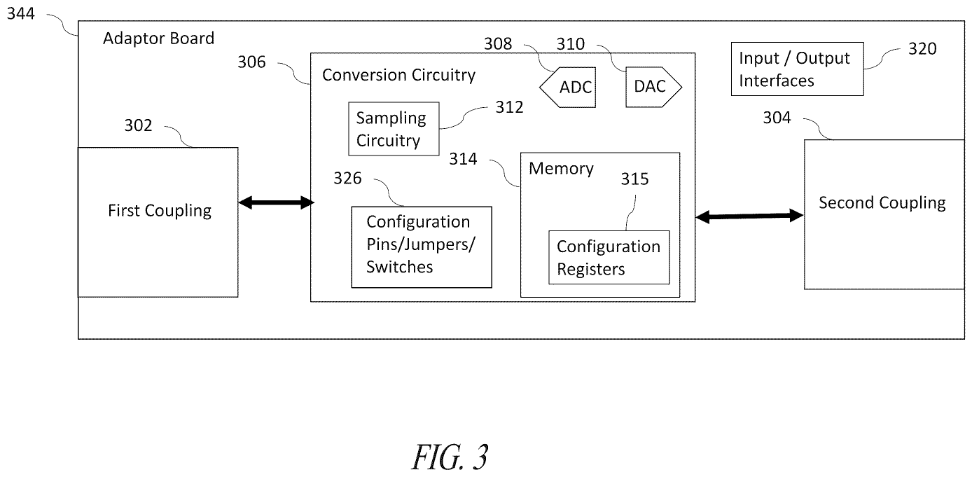

FIG. 3 is a functional block diagram of an embodiment of an adaptor board or circuit 344 that can be employed, for example, as an adaptor board or circuit 144 of the MCS system 140 of FIG. 1. The Adaptor board 344 as illustrated has a first coupling 302 of a first type, a second coupling 304 of a second type, and conversion circuitry 306 coupled between the first coupling 302 and the second coupling 304. The conversion circuitry 306, in operation, converts signals received via the first coupling for transmission via the second coupling, and converts signals received via the second coupling for transmission via the first coupling. The signals can include power signals, control signals, clock signals, sensor signals, etc., and various combinations thereof. The adaptor board 344 can be implemented as a system on a chip (SoC). The conversion processes performed by the adaptor board can include converting signals, converting signal connections, or combinations thereof.

The conversion circuitry 306 can include analog to digital converters 308, digital to analog converters 310, sampling circuitry 312, a memory 314, an input/output interface 320, configuration pins/jumpers/switches 326, a microprocessor, a programmable logic circuit, discrete circuitry, logic gates, etc., and various combinations thereof. The memory 314 can include volatile or non-volatile memories, which can store, for example, all or part of instructions and data related to applications and operations performed by the adaptor board 344. As illustrated, the memory 314 includes one or more configuration registers 315, which can store thresholds, control flags, pointers, and other configuration information related to the configuration or operation of the MCS. The configuration pins/jumpers/switches 326 store configuration information which may be sampled or read during configuration or at boot time as part of a process of configuring a MCS, or at run-time to control the operation of the MCS. The one or more input/output interfaces 320 can transmit and receive control signals and information in a manner similar to that described above with reference to the input output interface 220 of FIG. 2.

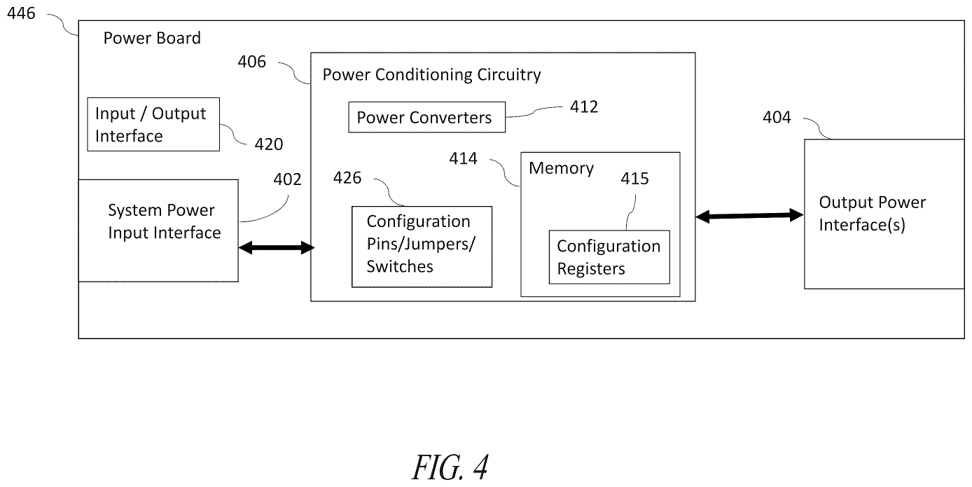

FIG. 4 is a functional block diagram of an embodiment of power board or circuit 446 that can be employed, for example, as a power board or circuit 146 of the MCS system 140 of FIG. 1. The power board 446 as illustrated has a system power input interface 402 to receive power input to the MCS system, such as via one or more power buses of an automobile, a line voltage (e.g., 120 volts AC/240 volts AC), etc., one or more output power interfaces 404 to provide power to one or more components of the MSC system (e.g., to a control board, to an adaptor board, to a motor, etc.), and power conditioning circuitry 406 to condition power provided by the power board 446 via the one or more output power interfaces 404.

The power conditioning circuitry can include one or more power converters 412, a memory 414, configuration pins/jumpers/switches 426, a microprocessor, a programmable logic circuit, discrete circuitry, logic gates, etc., and various combinations thereof. The memory 414 can include volatile or non-volatile memories, which can store, for example, all or part of instructions and data related to applications and operations performed by the power board 446. As illustrated, the memory 414 includes one or more configuration registers 415, which can store thresholds, control flags, pointers, and other configuration information related to the configuration or operation of the power board 446. The configuration pins/jumpers/switches 426 store configuration information which may be sampled or read during configuration or at boot time as part of a process of configuring a MCS, or at run-time to control the operation of the MCS. The one or more input/output interfaces 420 can transmit and receive control signals and information in a manner similar to that described above with reference to the input output interface 220 of FIG. 2. The power converters 412 can include voltage converters, DC/AC converters (inverters), AC/DC converters, switching converters, etc., and various combinations thereof.

The inverter board 147 of FIG. 1 can be a single board including circuitry to provide the functionality of control board 142 and the power board 146. A configured MCS system can include a single inverter board 147 coupled to a motor 148, without the need to employ separate control, adaptor and power boards.

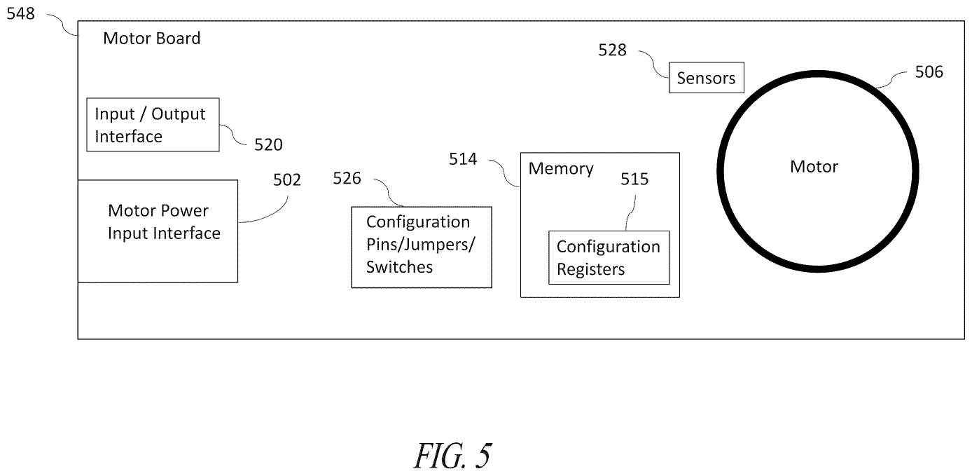

FIG. 5 is a functional block diagram of an embodiment of motor board 548 that can be employed, for example, as a motor 148 of the MCS system 140 of FIG. 1. The motor 548 as illustrated has a motor power input interface 502 to receive a power signal such as via one or more power buses of an automobile, from a control board, an adaptor board, or a power board of an MCS, etc., to drive a motor 506. The motor board 548 can include a memory 514, configuration pins/jumpers/switches 526, a microprocessor, a programmable logic circuit, discrete circuitry, logic gates, etc., and various combinations thereof. The memory 514 can include volatile or non-volatile memories, which can store, for example, all or part of instructions and data related to applications and operations performed by the motor board 548. As illustrated, the memory 514 includes one or more configuration registers 415, which can store thresholds, control flags, pointers, and other configuration information related to the configuration or operation of the motor board 548. The configuration pins/jumpers/switches 526 store configuration information which may be sampled or read during configuration or at boot time as part of a process of configuring a MCS, or at run-time to control the operation of the MCS. The one or more input/output interfaces 520 can transmit and receive control signals and information in a manner similar to that described above with reference to the input output interface 220 of FIG. 2. As illustrated, the motor board 548 includes one or more sensors 528 (e.g., encoders, temperature sensors, pressure sensors, motion sensors, etc.), which can provide sensor data for use in controlling the configured motor control system, such as via the one or more input/output interfaces 520. In some embodiments, a motor 506 can be directly coupled to a single board (e.g., an inverter board; a power board which is coupled to a control board; a power board which is coupled to a control board via an adaptor board). In some embodiments, a system can include a motor 506 which is not mounted to a motor board 548 (e.g., a plain motor).

Embodiments of the control board 242 of FIG. 2, of the adaptor board 344 of FIG. 3, of the power board 446 of FIG. 4, and of the motor board 548 of FIG. 5 can include fewer components than illustrated, can include more components than illustrated, can combine or separate components in various manners, and can be combined or separated in various manners. For example, as discussed above, an inverter board can provide the functionality of the control board and the power board; in some embodiments, the control board can include sensors, etc.

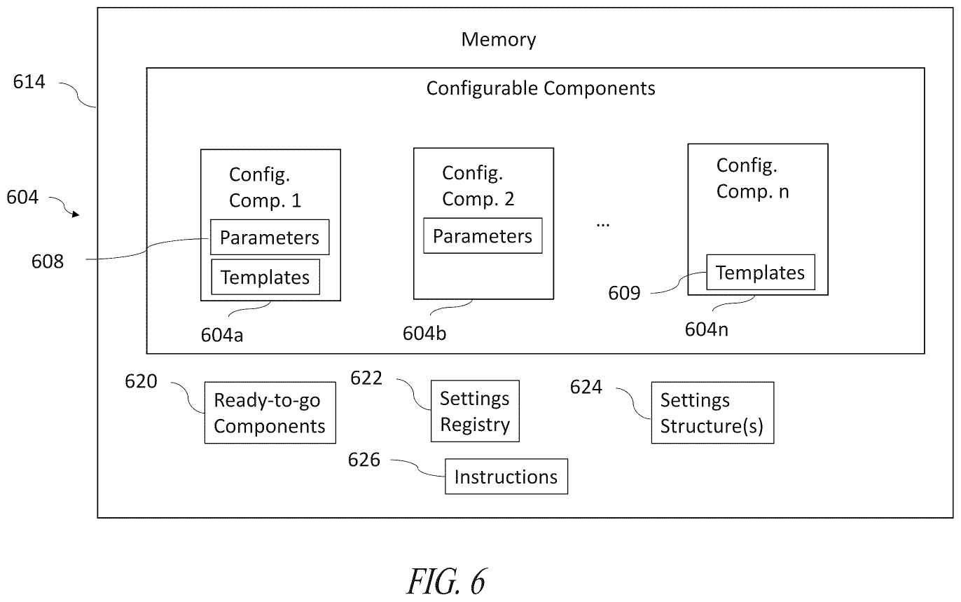

FIG. 6 is a block diagram showing an example conceptual structure of a memory 614 for storing aspects utilized in generating content in accordance with embodiments described herein. The memory 614 can be the memory 114 of the host computing device 110 from FIG. 1.

The memory 614 can store configurable components 604, ready-to-go components 620, a global map or settings registry 622, and settings structures for each configurable component 624. In some embodiments, the global map or settings registry 622 and the settings files may be combined. Memory 614 can also store computer instructions 626 that are executable by a processor (e.g., processor 112 in FIG. 1) to perform embodiments described herein. The data stored in the memory 614 may utilize standard syntax, e.g., JSON schema, which can enable the use of standard libraries using or taking benefit from that syntax, e.g., JSON forms.

Configurable components 604 include at least one configurable component 604a-604n. The configurable components 604a-604n include or describe some configuration, control, implementation, or functionality associated with software or hardware aspects of a configurable MCS device, such as one or more configurable components of the configurable motor control system 140 in FIG. 1. These configurable components 604a-604n have one or more parameters (e.g., constraints or variables) that can be selected, or set by the user.

Configurable components 604a-604n can include parameters files, template files, or both. Parameters 608 can include one or more files that store parameters of the configurable component that can be selected or set by the user. The parameters 608 can store the possible values the user can select for one or more parameters. These values can be direct values, advanced expressions, queries to the global map or settings registry, or queries to other parameters (e.g., other parameters 608) or to databases (not illustrated). The parameters 608 can be used to configure or implement one or more software or hardware aspects associated with the configurable MCS. In various embodiments, one or more generic or customized grammar structures may be utilized to write or generate the parameters 608. This grammar is a set of rules indicating how to express the configurability of a component or template.

In various embodiments, one or more parameters of the parameters 608 may be at least partially defined or limited by another parameter, component, or template. Accordingly, one or more parameters can be dependent on one or more other parameters, components, or templates, which can create various dependencies among parameters.

Templates 609 may include one or more files that store previously generated templates. The templates 609 are configuration tools for the configurable MCS. The templates 609 can be files that contain instrumented content that is used to generate content to initialize, configure, or control a software or hardware aspect of the configurable MCS 140. In some embodiments, the templates 609 contain C code instrumented with handlebars templating language. At a content generation stage, the instrumented parts may be replaced by information coming from the global map or settings registry 622, which is described in more detail below.

The ready-to-go components 620 are previously designed components that configure or pilot one or more software or hardware aspects of the programmable computing device. In at least one embodiment, the ready-to-go components 620 can also be referred to as non-configurable components. In various embodiments, the ready-to-go components 620 do not include any user-selectable features. Rather, the ready-to-go components 620 are fully operational and can configure or implement one or more software or hardware aspects of the programmable computing device without further input or selections by the user. As discussed in more detail below, the user may be presented with a graphical user interface in which the user can select to add or remove ready-to-go components from a project.

The settings for a configurable component 624 are optional and store the results of the configuration choices for each of the user-selected configurable components, parameters, and templates. For example, the specific settings for a configurable component 624 may identify one or more templates from the templates 609 that were selected by the user. The settings for a configurable component 624 can also contain the values associated to the parameters 608 that were selected by the user. In some embodiments, the settings for a configurable component 624 can also store optional user settings for software or hardware aspects of the configurable MCS device. In some embodiments, the settings for a configurable MCS device 624 can be employed for debugging purposes.

In some embodiments, a single settings structure 624 is generated for each selected configurable component 604. In other embodiments, multiple settings structures 624 are generated for a single selected configurable component 604. In yet other embodiments, a single settings structure 624 may be generated for multiple selected configuration components 604. Moreover, multiple settings structures 624 can be generated for multiple selected configuration components 604. In some embodiments, these settings structures 624 may be stored as JSON files.

The global map or settings registry 622 is an in-memory object centralizing all the user selections and settings that are generated via the user's selection of configurable components 604, parameters, and templates. The global map or settings registry in-memory object also may be stored and synchronized with a file to facilitate its persistence. By extension, the global map or settings registry 622 also can refer to a software component providing a dictionary, getters/setters, or services to compute or re-compute content for a programmable computing device based on expressions or dependencies. Overall, the global map or settings registry 622 is a dictionary or database memorizing software components settings and hardware platform settings of the programmable MCS device. In some embodiments, separate global maps or settings registries may be generated for various software and hardware aspects of the configurable MCS.

As described herein, the global map or settings registry 622 is a software component implementing a set of services to retrieve, store, compute, re-compute, or resolve values selected by the user. In various embodiments, the global map or settings registry 622 may comprise a JSON object with a set of accessors (API) to the components, templates, and parameter values selected by the user. In some embodiments, the global map or settings registry 622 can be a concatenation of all the settings for each configurable component 624 selected for a project.

As discussed in more detail below, the host computing device, such as host computing device 100 in FIG. 1, utilizes the global map or settings registry 622, along with the selected configurable components 604 and any selected ready-to-go components 620, to generate content that is provided to and used by the configurable MCS 140 to implement, control, or configure one or more software aspects of the configurable MCS 140, one or more hardware aspects of the configurable MCS 140, or both.

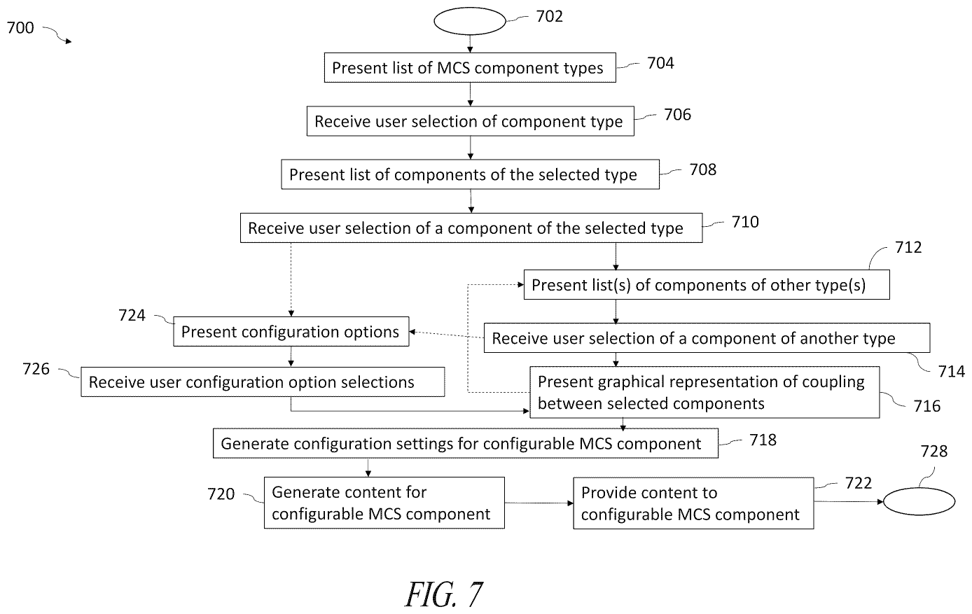

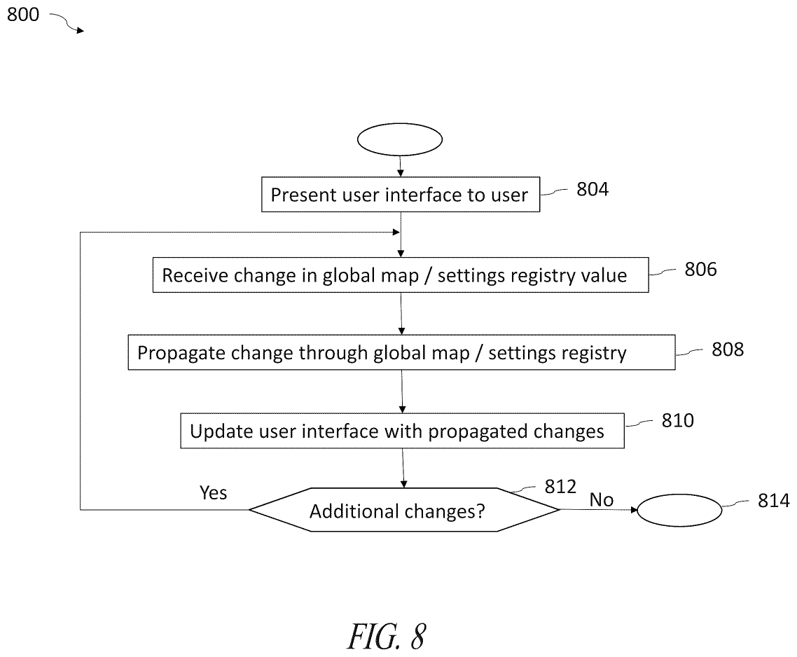

The operation of one or more embodiments will now be described with respect to FIGS. 7 and 8, and for convenience will be described with respect to the embodiments of FIGS. 1-6 described above. In at least one of various embodiments, processes 700 and 800 can be implemented by or executed on one or more computing devices, such as host computing device 110 in FIG. 1 executing instructions, such as instructions 626 (see FIG. 6) stored in the memory 614.

FIG. 7 shows a logical flow diagram of a process 700 for generating content in accordance with embodiments described herein. Process 700 begins, after a start block 702, at block 704, where a list of a plurality of component types for a motor control system are presented to the user in a graphical user interface. In at least one embodiment, the list of component types may be generated for the user based on particular user-selected constraints for a motor control system configuration project. The list of component types presented to the user can be dependent on these user selected constraints. The list of component types may include motors and a plurality of motor control system board types, such as control boards, adaptor boards, power boards, inverter boards, etc. Process 700 continues at block 706, where a user selection of a component type is received. In at least one embodiment, a user may select a component type from the list via the graphical user interface.

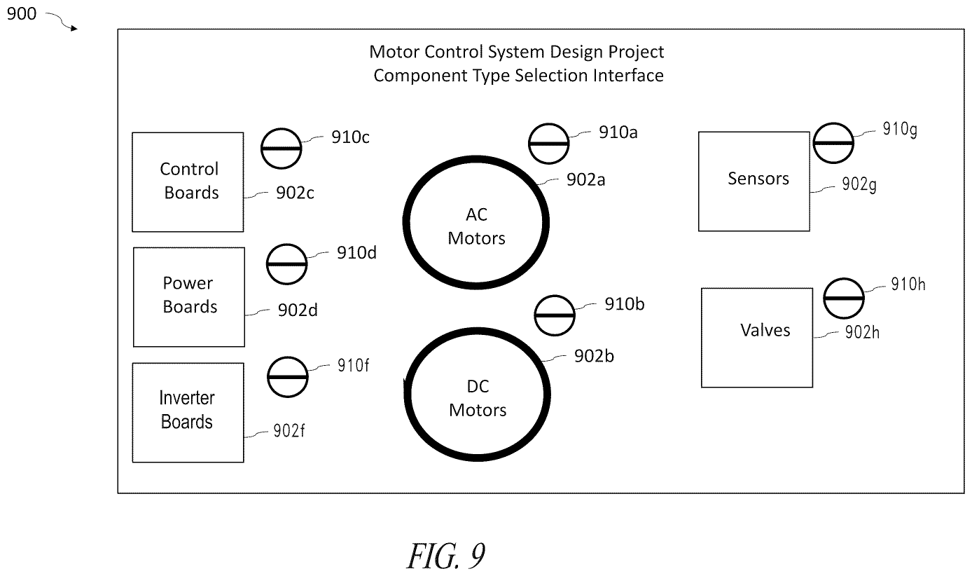

FIG. 9 is a conceptual diagram illustrating an example graphical user interface 900 presenting a list of component types 902a-902h to a user at block 704 for receiving a user selection of a component type at block 706. As illustrated, the component types include AC motors, DC motors, control boards, power boards, adaptor boards, inverter boards, sensors and valves. Some embodiments of a graphical user interface 900 can include fewer or more component type selection options. For example, some embodiments can include AC motors and DC motors in a single motor selection option of the graphical user interface 900, some embodiments may not include optional sensors, valves, etc., as components that are configurable via the graphical user interface. For example, sensors, valves, etc., can be ready-to-go components, or absent. The interface 900 also includes drop-down or pop-up menu selectors 910a-910h to facilitate the use of pop-up menus or drop down menus to select a particular component of a selected component type as discussed below with reference to blocks 708 and 710.

Process 700 proceeds next to block 708, where a list of a plurality of components of the selected type are presented to the user in a graphical user interface. In at least one embodiment, the list of components of the selected types can be generated for the user based on particular constraints for a motor control system configuration project. The list of components of the selected type presented to the user can be dependent on these user selections. Process 700 continues at block 710, where a user selection of a particular component of the selected type is received. In at least one embodiment, a user may select a particular component of the selected type from the list via the graphical user interface. The list may be presented to a user via a drop down menu or a pop-up menu.

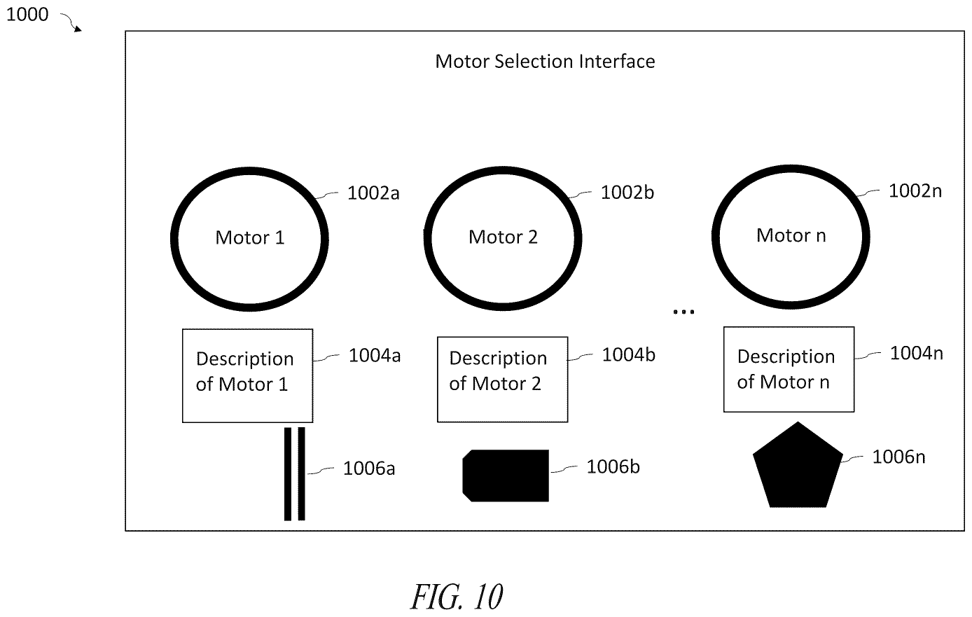

FIG. 10 is a conceptual diagram illustrating an example graphical user interface 1000 presenting a list of components of a selected type 1002a-1002n to a user at block 708 for receiving a user selection of a particular component of the selected type at block 710. As illustrated, the selected component type is a motor (e.g., selected at block 706), and particular motor options available 1002a-1002n are presented to the user for selection, and can include descriptions 1004a-1004n or graphical illustrations 1006a-1006n of characteristics of the corresponding motor 1002a-1002n. The described characteristics can motor type, operating voltages, operating currents, available couplings, etc. The illustrated characteristics can include a representation of available couplings, built in sensor capabilities, etc. The available couplings can be indicated using custom icon shapes to facilitate indicating the compatibility of the components with other components of the configurable motor control system. Colors can be used as well to indicate compatibility information, such as compatible couplings, etc. The graphical user interface 1000 of FIG. 10 can be a pop-up menu that is displayed in response to a component type selection in the graphical user interface 900 of FIG. 9.

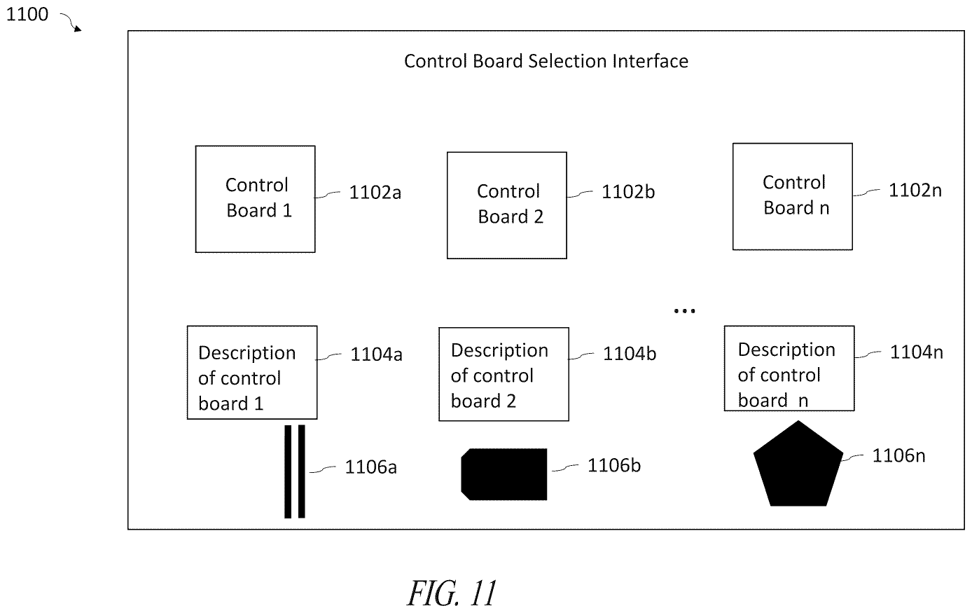

FIG. 11 is a conceptual diagram illustrating another example graphical user interface 1100 presenting a list of components of a selected type 1102a-1102n to a user at block 708 for receiving a user selection of a particular component of the selected type at block 710. As illustrated, the selected component type is a control board (e.g., selected at block 706), and particular control board options 1102a-1102n are presented to the user for selection, and can include descriptions 1104a-1104n or illustrations 1106a-1106n of characteristics of the corresponding control board 1102a-1102n. The described characteristics can operating voltages, available couplings, etc. The illustrated characteristics can include a representation of available couplings, built in sensor capabilities, etc. The graphical user interface 1100 of FIG. 11 can be a pop-up menu that is displayed in response to a selection in the graphical user interface 900 of FIG. 9. Similar graphical user interfaces may be employed when other component types are selected at 706 (e.g., an adaptor board component type is selected at block 706, an inverter board component type is selected at block 706, a power board component type is selected at block 706, etc.).

Process 700 proceeds to block 712 where one or more lists of components of one or more other types are presented to the user in a graphical user interface based on the selection of a particular component of the selected type at block 710. In addition, in at least one embodiment, the list of components of the one or more other types can be generated for the user based on particular constraints for a motor control system configuration project. The one or more lists of components of one or more other types presented to the user can also be dependent on these user selections. Process 700 continues at block 714, where a user selection of a particular component of the one or more other types is received. In at least one embodiment, a user may select a particular component of the one or more other types from the one or more lists via the graphical user interface.

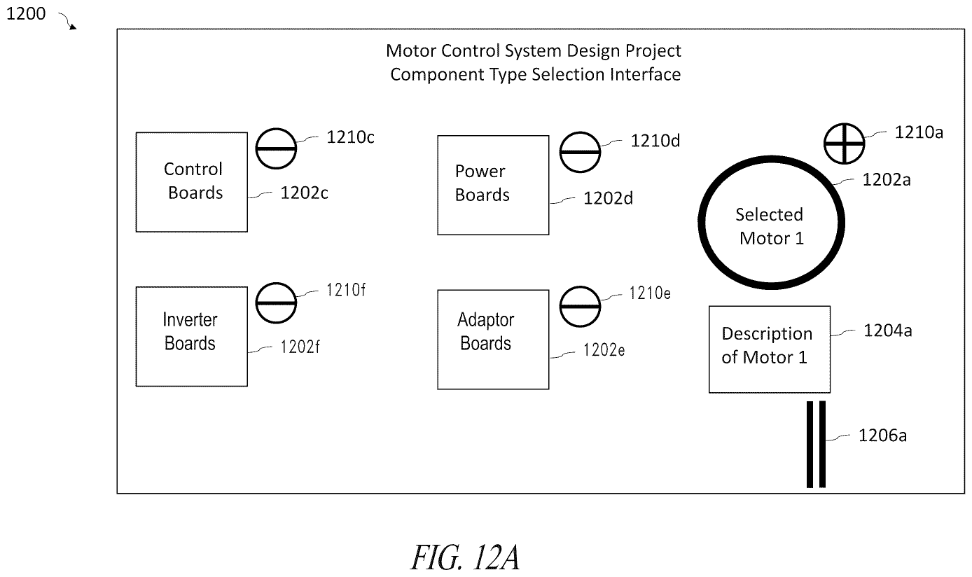

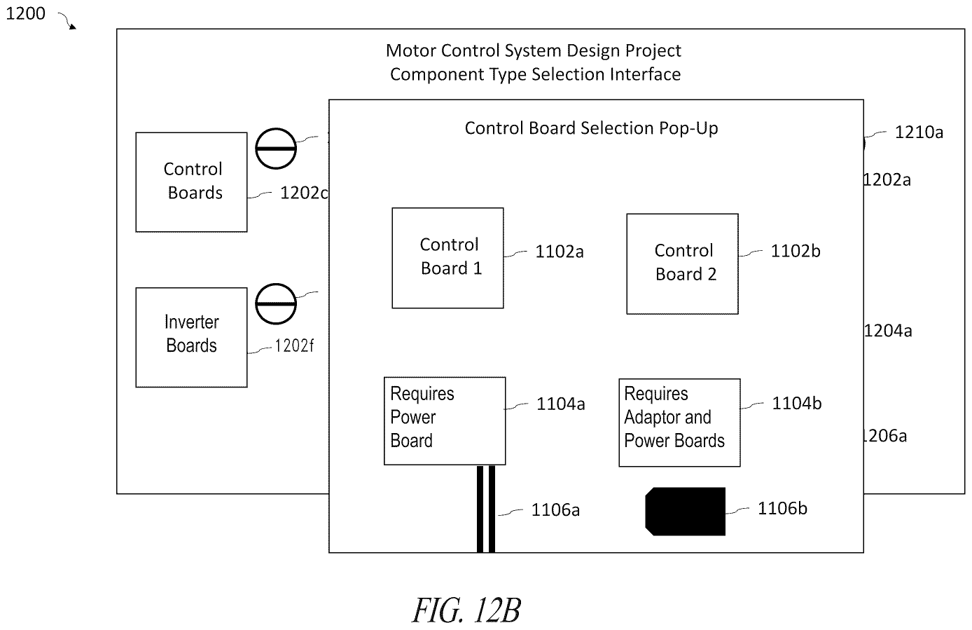

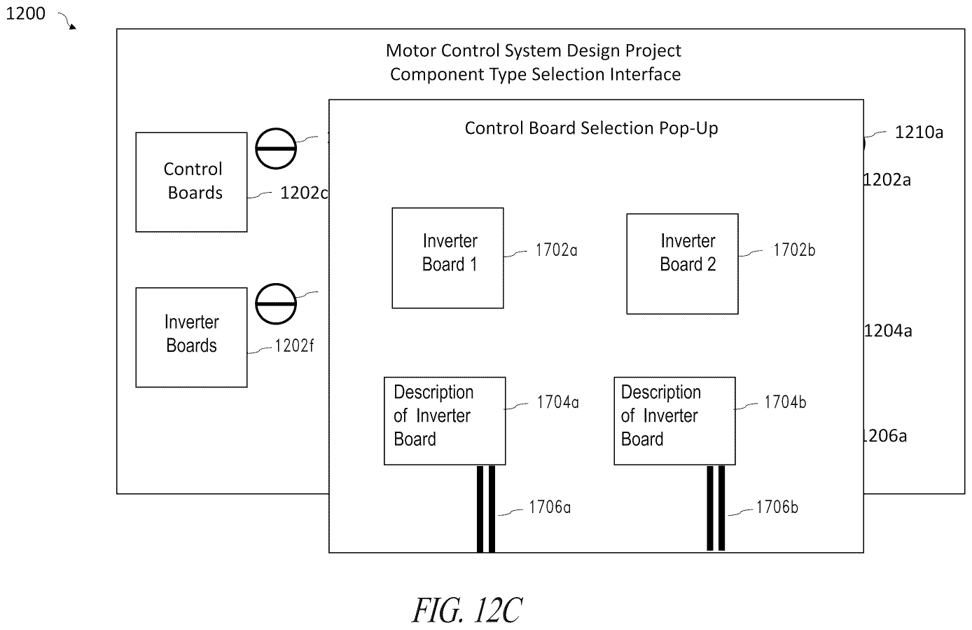

FIGS. 12A to 12C are conceptual diagrams illustrating an example graphical user interface 1200 presenting one or more lists of components of other types to a user at block 712 for receiving a user selection of a particular component of another type at block 714. As illustrated in FIG. 12A, a particular motor Motor 1 was selected at block 710, and the graphical user interface includes an identification of the selected motor 1202a, a description of characteristics of the selected motor 1204a, and a graphical illustration of characteristics of the selected motor 1206a. As illustrated, the selected motor is compatible with certain control boards, with certain power boards, with certain adaptor boards, and with certain inverter boards, which can be determined based on component configuration information stored in the memory 614. The user can select to see a list of the compatible control boards by selecting drop-down or pop-up menu selector 1210c, can select to see a list of compatible power boards by selecting drop-down or pop-up selector 1210d, etc. It is noted that compatible boards can include boards that require additional components to correspond to a valid system configuration.

FIG. 12B illustrates a pop-up menu the graphical user interface 1200 can employ when the control board pop-up selector 1210c is selected. As illustrated, the pop-up menu includes two of the control board selections 1102a and 1102b of user interface 1100 of FIG. 11. The descriptions 1104a, 1104b and illustrations 1106a, 1106b of characteristics of the corresponding control board 1102a, 1102b indicate control board 1 can be coupled to the selected motor Motor 1 via a power board, and indicate that control board 2 requires an adaptor board and a power board. If control board 1 is selected, an additional pop-up menu can indicate power boards compatible with the control board 1 and the selected motor. If control board 2 is selected, additional pop-up menus can indicate compatible adaptor boards and power boards for selection.

FIG. 12C illustrates a pop-up menu the graphical user interface 1200 can employ when the inverter board pop-up selector 1210f is selected. As illustrated, the pop-up menu includes two inverter board selections 1702a and 1702b. The descriptions 1704a, 1704b and illustrations 1706a, 1706b of characteristics of the corresponding inverter board 1702a, 1702b indicate inverter board 1 and inverter board 2 can be coupled directly to the selected motor Motor 1.

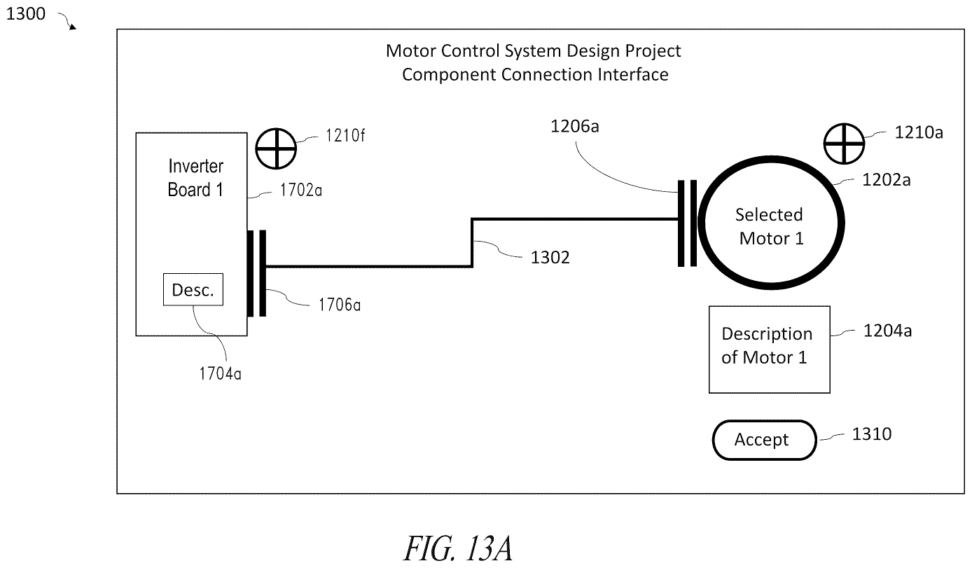

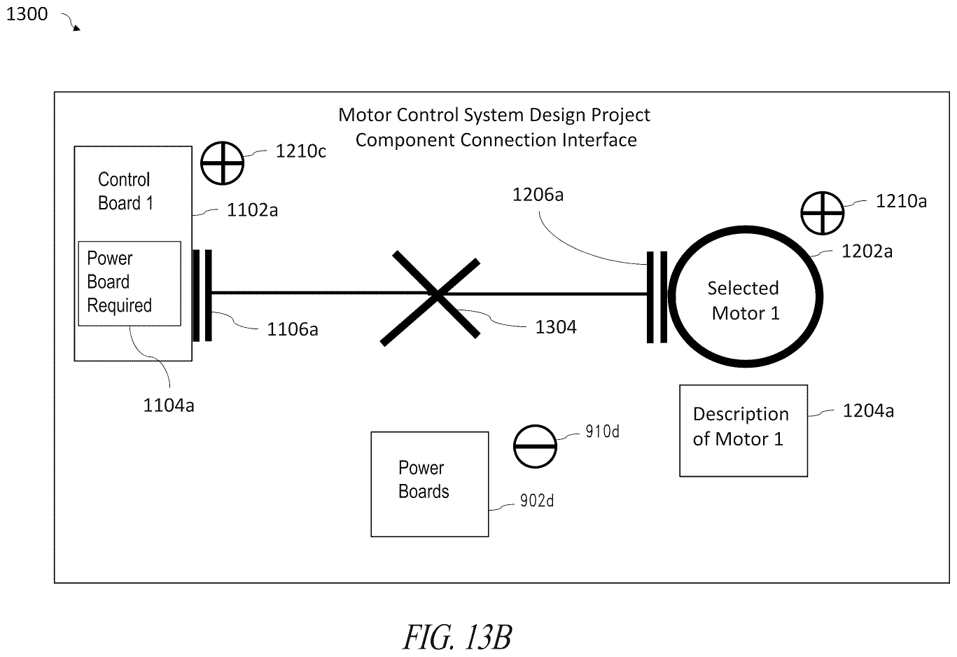

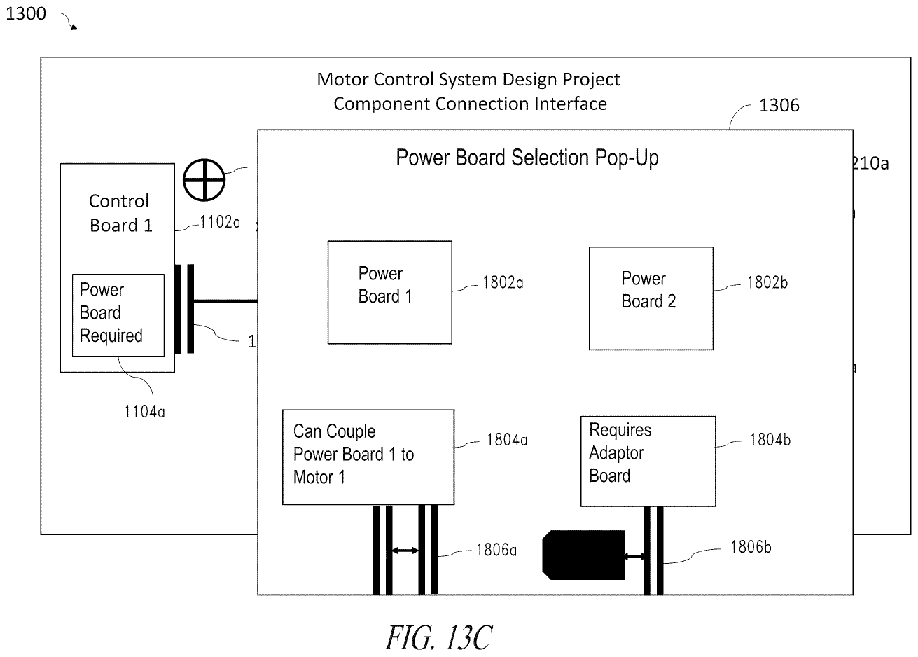

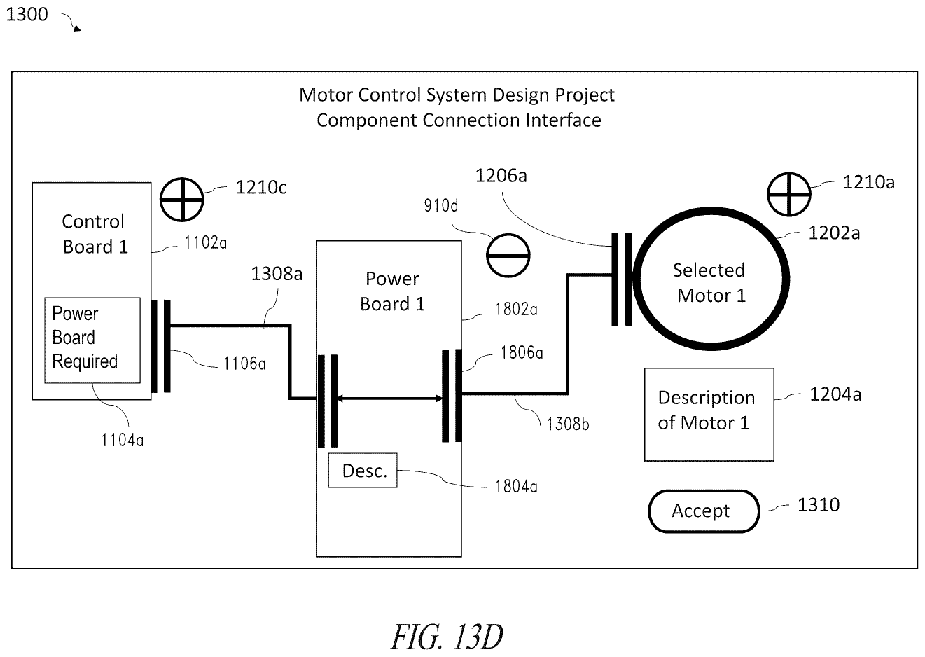

Process 700 proceeds to block 716 where a graphical representation of a coupling between the component selected at 710 and the component selected at 714 is presented via the graphical user interface. FIGS. 13A-13D illustrates example graphical user interfaces showing couplings between a selected motor and various system boards according to example embodiments.

FIG. 13A shows an example representation when a selected inverter board (Inverter Board 1 as illustrated) can be coupled to the selected motor (Selected Motor 1), without the need for additional boards (e.g., without an adaptor board or a power board). The coupling 1706a of the selected inverter board 1702a is compatible with the coupling 1206a of the selected motor 1202a, and can be connected directly to the motor or connected using a cable or connection 1302. The graphical representation of the graphical user interface 1300 shows the couplings are compatible. As mentioned above, custom icon shapes and colors can be used to illustrate the compatibility of the selected components. If the configuration is complete with the selection of the inverter board and motor, and acceptable to the user, the user can accept the configuration using the accept selector 1310, and the process 700 can proceed to block 718, discussed below. Otherwise, the user can make changes to selections and configurations, for example by selecting one of the pop-up or drop-down menu selectors 1210f, 1210a. It is noted that the graphical user interface 1300 may include a selection to return to a previous menu, such as the menu 1200 of FIG. 12A, or may automatically do so in response to a de-selecting of a selected component.

FIGS. 13B-13D show example representations when a selected control board (Control Board 1) needs a power board to couple to the selected motor (Selected Motor 1). In FIG. 13B, the interface shows graphically and textually that the selected control board 1102a and the selected motor 1202a cannot be directly coupled together 1304. FIG. 13B does not include an accept selector (see accept selector 1310 of FIG. 13A), because a valid configuration has not been selected. The process 700 can return to 712 (illustrated using a dashed line in FIG. 7) so the interface 1300 can present the user with an option to select a power board by selecting a drop down or pop up menu selector 910d.

FIG. 13C illustrates an example pop up menu 1306 from which a compatible power board 1802a, 1802b can be selected. The pop up menu includes descriptions 1804a, 1804b and graphical representations 1806a, 1806b of the characteristics of the compatible power boards 1802a, 1802b, which indicate the power board is compatible with the selected control board and motor in the case of power board 1, and in the case of power board 2 that an adaptor board is needed.

FIG. 13D shows an example representation when the selected control board (Control Board 1), power board and motor can be configured to couple together without the need for an adaptor board. The coupling 1106b of the selected control board 1102b is compatible with the input of the coupling 1806a of the selected power board 1802a, and the coupling 1206a of the selected motor 1202a is compatible with the output of the coupling 1806a of the selected power board 1802a, and cables or connections 1308a, 1308b can be used to couple the components together. The graphical representation of the graphical user interface 1300 shows the couplings are compatible and how the connections can be completed. If the configuration is complete and the user is satisfied with the configuration of the selected the control board, power board and motor, the user can accept the configuration using the accept selector 1310, and the process 700 can proceed to block 718, discussed below. Otherwise, the process can return to block 712 (see dashed line between block 716 and block 712) to select additional components (e.g., if an adaptor power board is needed or desired) or to modify previous selections, for example by selecting one of the pop-up or drop-down menu selectors 1210c, 910d, 1210a. As noted above, the graphical user interface 1300 may include a selection to return to a previous menu, such as the menu 1200 of FIG. 12A, or may automatically do so in response to a de-selection of a selected component.

As components are selected at block 710 and 714, optionally a determination can be made as to whether a selected component is a user configurable component or a non-user configurable component. In some embodiments, the components may have a tag or other identifier indicating whether the component is configurable by the user or not. In other embodiments, a database or other data structure of configurable and non-configurable components may be maintained and compared against the selected component. If the selected component is user-configurable, the user may be presented with configuration options via the graphical user interface at block 724 and user configuration option selections may be received at block 726 via the graphical user interface. The process 700 flows from block 726 to block 716, where impacts of the selected configuration options may be graphically presented to the use via the graphical user interface. In various embodiments, blocks 724 and 726 may be optional and may not be performed

Process 700 continues from block 716 to block 718, where configuration settings for one or more configurable components of configurable motor control system are generated based on the user-selected components, and, if applicable, any user received configuration option selections. In some embodiments, generating the configuration settings can include generating settings structures 24, which can be a list or other data structure identifying the parameters and the associated values or other information indicating how the configurable component is to be customized.

In various embodiments, the settings structures may be updated by overlaying the user-selected information for the user-selected component to override some values of that component. In some embodiments, a component can override a parameter from another component, such as when components rely on one another for control of the configurable MCS. In other embodiments, a component can override a query from another component, such as by changing the choices the user can make associated with that component (e.g., adaptor boards that can be selected for a given selection of a control board and motor). Because some parameters can be set or defined by other templates or components, some parameter values may be propagated or overlaid based on the dependencies between parameters, templates, and components. For example, application-level values may override driver-level values. In this way, user selections and changes at the application level can change values or parameters at the driver level, which may then be reflected in the global map or system registry. In some embodiments the settings structure 624 and the global map or settings registry 622 may be combined.

At block 720, content for the configurable MCS components of the configured MCS system is generated based on the selected components and the information stored in the global map or settings registry 622. It is noted that information stored in the global registry and related to other components may be used to generate content. For example, information related to selected motor associated with a selected power board (e.g., operating characteristics of the motor) may be employed to generate content associated with the selected power board.

The global map or settings registry 622 may operate as a consolidated database of values that can be used to generate the content from the user-selected templates and user-selected components. This content may be, for example, plain code (e.g., C code) that is used by the configurable MCS component device to initialize, configure, or control a software or hardware aspect of the configurable MCS system. Accordingly, the generated content may be initialization code, application code, configuration code, a device tree blob (a hardware description interpreted at runtime), etc. The content may also be other settings, parameters, or other information that initializes, configures, or controls a software or hardware aspect of the configurable MCS. The content may also comprise associated documentation. The content generated can be built into one or more binary images for the project. This binary image is the information usable by the configurable MCS devices to initialize, configure, or control its hardware, software, or a combination thereof.

As illustrated, process 700 proceeds from block 720 to block 722, where the generated content is provided to the configurable MCS components (e.g., a binary image is provided to a configurable MCS component. After block 722, process 700 terminates or otherwise returns to a calling process to perform other actions.

FIG. 8 shows a logical flow diagram of a process 800 for updating a graphical user interface during the configuration process or the content generation process in accordance with embodiments described herein.

Process 800 begins, after a start block, at block 804, where a user interface of a MCS configuration project is presented to a user. In various embodiments, this user interface can be the graphical user interfaces displayed to the user described above with reference to FIG. 7. This user interface may display components that are selectable for use with a configurable MCS system, parameters selectable by a user for a particular configurable component, templates selectable by the user for a particular configurable component, and other information. Moreover, the user interface may display the values of various parameters, settings, templates, and components, whether selected by a user, linked from one template to another, dependent on other values, or defined by a template or selected component, which may be predefined.

Process 800 proceeds from block 804 to block 806, where a change in a global map or settings registry value is received. As described above, the global map or settings registry can be updated in response to a user-selected MCS component, a user-selected parameter value, a user-selected template, a user selected coupling, etc. These user-selectable conditions may indicate a change in a global map or settings registry value.

Process 800 continues from block 806 to block 808, where the change is propagated through the global map or settings registry. Because parameters, templates, and components can rely or depend on values of other parameters, templates, components, or projects, a change in one value can result in a change in another. Thus, the received change in the global map or settings registry value is propagated through the global map or settings registry in accordance with these dependencies.

Process 800 proceeds next from block 808 to block 810, where the user interface is updated based on the propagated changes in the global map or settings registry. The user-interface also may be updated based on generated content. In some embodiments, the user interface queries the global map or settings registry, and any changes that occurred while updating the global map or settings registry are obtained and displayed in the user interface.

Process 800 continues next at decision block 812, where a determination is made whether additional changes are to be made to the MCS configuration. If so, process 800 flows to block 806, to receive another change to a global map or settings registry value from a user.

Embodiments of the process 700 illustrated in FIG. 7 and of the process 800 illustrated in FIG. 8 may have more process blocks than illustrated, may have fewer process blocks than illustrated, and the process flow may be modified in various ways. For example, process blocks 710-722 may be performed in an iterative manner, with a user being able to modify selections on the fly and be presented with a graphical representation of the impacts of any modifications. In another example, as components are presented to the user at block 712 and selected by the user at block 714, selection checks can be performed by the system 110 (e.g., software coherency checks, electrical behavior checks, coupling compatibility checks, etc.). This may be done, for example, based on the global map or settings registry 622, the settings files 624 or other temporary selection indicators (e.g., prior to completing of a configuration project and updating of the global map or settings registry 622), stored information regarding characteristics of the components thereof, etc., and various combinations thereof. The results of such selection checks may be included in the graphical representations at blocks 712, 716, etc. In another example, process 700 may be modified to present other selection lists, such as lists of cables or connectors that are compatible with selected components, or to provide information identifying cables and connectors that can be used to couple the components together.

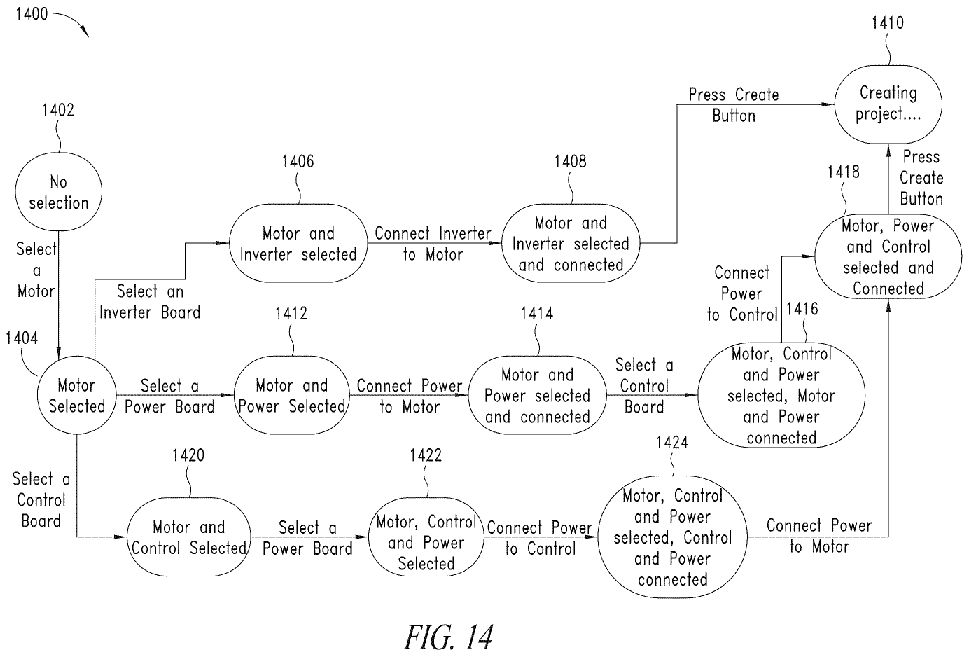

FIG. 14 is a flow diagram of a process 1400 of configuring a motor control system in accordance with embodiments described herein. At 1402, no selection of a component of the motor control system has been made. At 1404, an initial component has been selected, as illustrated, a motor, and the graphical user interface is updated to reflect the selection. While in FIG. 14 the initial selection of a component is a selection of a motor, the initial selection can be a selection of a different component of a motor control system (e.g., a power board, an inverter board, a control board, an adaptor board, etc.). At 1404, the user is presented with options via the graphical user interface.

A first option illustrated in FIG. 14 is for the user to select an inverter to couple to the selected motor, and if this option is selected, the graphical user interface is updated to show the motor and inverter have been selected at 1406. The user can then select to connect the selected motor and inverter (and can be prompted to do so) via the graphical user interface. At 1408, the graphical user interface is updated to reflect the selected motor and inverter have been connected. If the user is satisfied with selected configuration, the user can select to proceed to create the configured motor control system (e.g., by pressing a create button), and in response a project can be created at 1410 (e.g., configuration settings for the configurable MCS system can be generated).

A second option illustrated in FIG. 14 is for the user to select a power board to couple to the selected motor, and if this option is selected, the graphical user interface is updated to show the motor and power board have been selected at 1412. The user can then select to connect the selected motor and power board (and can be prompted to do so) via the graphical user interface. At 1414, the graphical user interface is updated to reflect the selected motor and power board have been connected, and the user can be prompted via the graphical user interface to select a control board from a selection of control boards that are compatible with the selected motor and power board. At 1416, the graphical user interface is updated to reflect that the motor, control board and power board have been selected, and the motor and power board connected. The user can then select to connect the selected control board to the power board (and can be prompted to do so) via the graphical user interface. At 1418, the graphical user interface is updated to reflect that the motor, power board, and control board have been selected and connected. If the user is satisfied with selected configuration, the user can select to proceed to create the configured motor control system (e.g., by pressing a create button), and in response a project can be created at 1410 (e.g., configuration settings for the configurable MCS system can be generated and provided to configurable components of the MCS system).

A third option illustrated in FIG. 14 is for the user to select a control board to couple to the selected motor, and if this option is selected, the graphical user interface is updated to show the motor and control board have been selected at 1420. The user can then select a compatible power board (and can be prompted to do so) via the graphical user interface. At 1422, the graphical user interface is updated to reflect the motor, control board and power board have been selected. The user can select to connect the power board to the control board (and may be prompted to do so) via the graphical user interface. At 1424, the graphical user interface is updated to reflect that the motor, control board and power board has been selected, and the control and power boards have been connected. The user can then select to connect the selected power board to the motor (and can be prompted to do so) via the graphical user interface. At 1418, the graphical user interface is updated to reflect that the motor, power board, and control board have been selected and connected. If the user is satisfied with selected configuration, the user can select to proceed to create the configured motor control system (e.g., by pressing a create button), and in response a project can be created at 1410 (e.g., configuration settings for the configurable MCS system can be generated and provided to configurable components of the MCS system). The options presented and the flows of FIG. 14 are examples only, other selections and flows are possible.

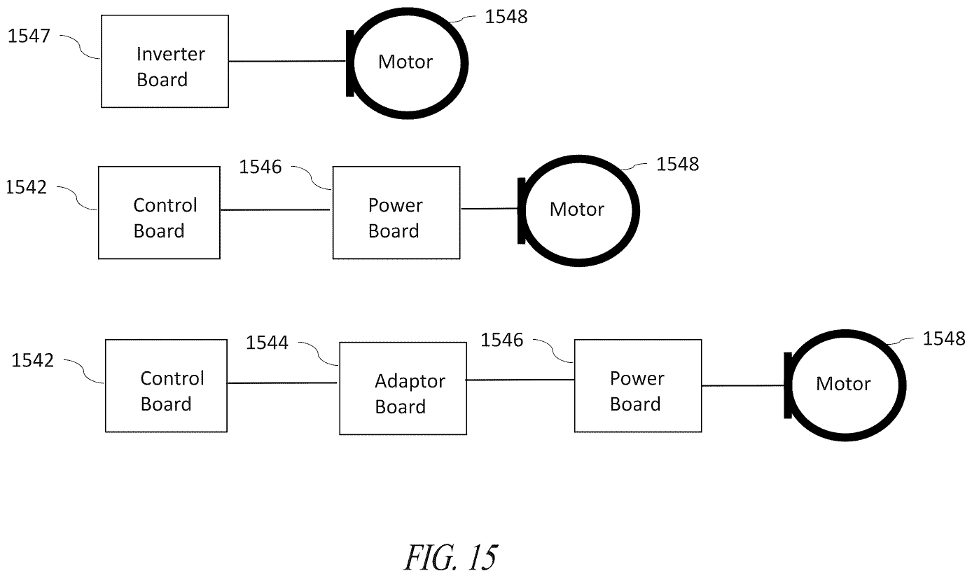

FIG. 15 is a conceptual diagram illustrating example configurable motor control systems that can be configured using the processes 700 and 800 of FIGS. 7 and 8. A first example motor control system includes an inverter board 1547 coupled to a motor 1548. A second example motor control system includes a control board 1542 coupled to a motor 1548 via a power board 1546. A third example motor control system includes a control board 1542 coupled to a motor 1548 via an adaptor board 1544 and a power board 1546.

In an embodiment, a method of generating content for a configurable motor control system is performed by a processing device. The method includes presenting, via a graphical user interface, a first list of types of motor control system components, the first list of types of motor control system components including motors and a plurality of system board types. A first selection of a first type of motor control system component from the first list of types of motor control system components is received via the graphical user interface. In response to the first selection of a first type of motor control system component from the first list of types of motor control system components, a second list of motor control system components of the first type is presented via the graphical user interface, and a second selection of a motor control system component of the first type from the second list of motor control system components of the first type is received via the graphical user interface. In response to the second selection of the motor control system component of the first type, a third list of motor control system components of a second type different from the first type is presented via the graphical user interface, and a third selection of a motor control system component of the second type from the third list of motor control system components of the second type is received via the graphical user interface. In response to the third selection of the motor control system component of the second type, a representation of a physical coupling between the selected motor control system component of the first type and the selected motor control system component of the second type is presented via the graphical user interface. Configuration settings for a configurable motor control system component are generated based on the selected motor control system component of the first type and the selected motor control system component of the second type, content for the configurable motor control system component is generated based on the configuration settings, and the generated content is provided to the configurable motor control system component.

In an embodiment, the selected first type is a motor type. In an embodiment, the selected first type is a system board type. In an embodiment, the system board types include control boards, adapter boards, inverter boards, and power boards.

In an embodiment, the presenting, via the graphical user interface, a second list of motor control system components of the first type includes presenting a representation of physical, logical or physical and logical characteristics of components of the list of components of the first type.

In an embodiment, the presenting, via the graphical user interface, a third list of motor control system components of a second type different from the first type includes identifying motor control system components of the second type that are compatible with the selected motor control system component of the first type. In an embodiment, the identifying includes verifying a logical and physical compatibility of the motor control system components of the second type with the selected motor control system component of the first type.

In an embodiment, the method comprises presenting a list of a third type of components of the motor control system based on the selected component of the first type and the selected component of the second type. In an embodiment, the third type of components of the motor control system are adaptor boards. In an embodiment, the third type of components of the motor control system are power boards.

In an embodiment, the method comprises: in response to receiving a fourth selection of a motor control system component of the third type, detecting a change to a first value in the configuration settings for the configurable motor control system component based on the fourth selection.

In an embodiment, the generating configuration settings includes presenting settings options via the graphical user interface and receiving setting selections via the graphical user interface. In an embodiment, the setting options include voltage settings, current settings, pulse-width-modulation (PWM) settings, sensor settings, thresholds, or combinations thereof.

In an embodiment, the types of motor control system components include sensors and valves.

In an embodiment, the configurable motor control system component is the selected motor control system component of the first type or the selected motor control system component of the second type.

In an embodiment, generating the content comprises generating initialization code that initializes software of the configurable motor control system component, generating initialization code that initializes hardware of the configurable motor control system component, or generating initialization code that initializes software and hardware of the configurable motor control system component.

In an embodiment, generating the content comprises generating application code that controls software of the configurable motor control system component.

In an embodiment, the method comprises generating or updating a settings registry based on generated configuration settings for the configurable motor control system component, and generating the content for the configurable motor control system component based on the settings registry.

In an embodiment, the method comprises in response to the third selection of the motor control system component of the second type, presenting, via the graphical user interface, a fourth list of motor control system components of a third type different from the first and second types; receiving, via the graphical user interface, a fourth selection of a motor control system component of the third type from the fourth list of motor control system components of the third type; and in response to the fourth selection of the motor control system component of the third type, presenting, via the graphical user interface, a representation of physical couplings between the selected motor control system component of the first type, the selected motor control system component of the second type, and the selected motor system component of the third type.

In an embodiment, contents of a non-transitory computer-readable medium configure a processing device to perform a method of generating content for a configurable motor control system. The method includes presenting, via a graphical user interface, a first list of types of motor control system components, the first list of types of motor control system components including motors and a plurality of system board types. A first selection of a first type of motor control system component from the first list of types of motor control system components is received via the graphical user interface. In response to the first selection of a first type of motor control system component from the first list of types of motor control system components, a second list of motor control system components of the first type is presented via the graphical user interface, and a second selection of a motor control system component of the first type from the second list of motor control system components of the first type is received via the graphical user interface. In response to the second selection of the motor control system component of the first type, a third list of motor control system components of a second type different from the first type is presented via the graphical user interface, and a third selection of a motor control system component of the second type from the third list of motor control system components of the second type is received via the graphical user interface. In response to the third selection of the motor control system component of the second type, a representation of a physical coupling between the selected motor control system component of the first type and the selected motor control system component of the second type is presented via the graphical user interface. Configuration settings for a configurable motor control system component are generated based on the selected motor control system component of the first type and the selected motor control system component of the second type, content for the configurable motor control system component is generated based on the configuration settings, and the generated content is provided to the configurable motor control system component. In an embodiment, the contents of the computer-readable medium comprise instructions executable by the processing device. In an embodiment, the contents of the computer-readable medium comprise configuration option information associated with the configurable motor system component.

In an embodiment, a computing device includes a display device, a memory, which, in operation, stores computer instructions, and at least one processor, which, in operation, executes the computer instructions to generate and provide content to a configurable motor control system component. The generating the content includes presenting, via a graphical user interface, a first list of types of motor control system components, the first list of types of motor control system components including motors and a plurality of system board types. A first selection of a first type of motor control system component from the first list of types of motor control system components is received via the graphical user interface. In response to the first selection of a first type of motor control system component from the first list of types of motor control system components, a second list of motor control system components of the first type is presented via the graphical user interface, and a second selection of a motor control system component of the first type from the second list of motor control system components of the first type is received via the graphical user interface. In response to the second selection of the motor control system component of the first type, a third list of motor control system components of a second type different from the first type is presented via the graphical user interface, and a third selection of a motor control system component of the second type from the third list of motor control system components of the second type is received via the graphical user interface. In response to the third selection of the motor control system component of the second type, a representation of a physical coupling between the selected motor control system component of the first type and the selected motor control system component of the second type is presented via the graphical user interface. Configuration settings for a configurable motor control system component are generated based on the selected motor control system component of the first type and the selected motor control system component of the second type, content for the configurable motor control system component is generated based on the configuration settings. The generated content is provided to the configurable motor control system component.

In an embodiment, the presenting, via the graphical user interface, a second list of motor control system components of the first type includes presenting a representation of physical, logical or physical and logical characteristics of components of the list of components of the first type.

In an embodiment, the presenting, via the graphical user interface, a third list of motor control system components of a second type different from the first type includes identifying motor control system components of the second type that are compatible with the selected motor control system component of the first type.

In an embodiment, the identifying includes verifying a logical and physical compatibility of the motor control system components of the second type with the selected motor control system component of the first type.

The headings and Abstract of the Disclosure provided herein are for convenience only and do not limit or interpret the scope or meaning of the embodiments.

The various embodiments described above can be combined to provide further embodiments. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method performed by a processing device, the method comprising:
presenting, via a graphical user interface, a first list of types of motor control system components, the first list of types of motor control system components including motors and a plurality of system board types;
receiving, via the graphical user interface, a first selection of a first type of motor control system component from the first list of types of motor control system components;
in response to the first selection of a first type of motor control system component from the first list of types of motor control system components:
presenting, via the graphical user interface, a second list of motor control system components of the first type;
receiving, via the graphical user interface, a second selection of a motor control system component of the first type from the second list of motor control system components of the first type; and
in response to the second selection of the motor control system component of the first type:
presenting, via the graphical user interface, a third list of motor control system components of a second type different from the first type;
receiving, via the graphical user interface, a third selection of a motor control system component of the second type from the third list of motor control system components of the second type; and
in response to the third selection of the motor control system component of the second type, presenting, via the graphical user interface, a representation of a physical coupling between the selected motor control system component of the first type and the selected motor control system component of the second type;
generating configuration settings for a configurable motor control system component based on the selected motor control system component of the first type and the selected motor control system component of the second type;
generating content for the configurable motor control system component based on the configuration settings; and
providing the content to the configurable motor control system component.

2. The method of claim 1, wherein the selected first type is a motor type.

3. The method of claim 1, wherein the selected first type is a system board type.

4. The method of claim 1, wherein the system board types include control boards, adapter boards, inverter boards, and power boards.

5. The method of claim 1, wherein the presenting, via the graphical user interface, a second list of motor control system components of the first type includes presenting a representation of physical, logical or physical and logical characteristics of components of the list of components of the first type.

6. The method of claim 1, wherein the presenting, via the graphical user interface, a third list of motor control system components of a second type different from the first type includes identifying motor control system components of the second type that are compatible with the selected motor control system component of the first type.

7. The method of claim 6 wherein the identifying includes verifying a logical and physical compatibility of the motor control system components of the second type with the selected motor control system component of the first type.

8. The method of claim 1, comprising presenting a list of a third type of components of the motor control system based on the selected component of the first type and the selected component of the second type.

9. The method of claim 8, wherein the third type of components of the motor control system are adaptor boards.

10. The method of claim 8, wherein the third type of components of the motor control system are power boards.

11. The method of claim 8, comprising:
in response to receiving a fourth selection of a motor control system component of the third type, detecting a change to a first value in the configuration settings for the configurable motor control system component based on the fourth selection.

12. The method of claim 1 wherein the generating configuration settings includes presenting settings options via the graphical user interface and receiving setting selections via the graphical user interface.

13. The method of claim 12, wherein the setting options include voltage settings, current settings, pulse-width-modulation (PWM) settings, sensor settings, thresholds, or combinations thereof.

14. The method of claim 1 wherein the types of motor control system components include sensors and valves.

15. The method of claim 1 wherein the configurable motor control system component is the selected motor control system component of the first type or the selected motor control system component of the second type.

16. The method of claim 1, wherein generating the content comprises:
generating initialization code that initializes software of the configurable motor control system component, generating initialization code that initializes hardware of the configurable motor control system component, or generating initialization code that initializes software and hardware of the configurable motor control system component.

17. The method of claim 1, wherein generating the content comprises:
generating application code that controls software of the configurable motor control system component.

18. The method of claim 1, comprising:
generating or updating a settings registry based on generated configuration settings for the configurable motor control system component; and
generating the content for the configurable motor control system component based on the settings registry.

19. The method of claim 1, comprising:
in response to the third selection of the motor control system component of the second type,
presenting, via the graphical user interface, a fourth list of motor control system components of a third type different from the first and second types;
receiving, via the graphical user interface, a fourth selection of a motor control system component of the third type from the fourth list of motor control system components of the third type; and
in response to the fourth selection of the motor control system component of the third type, presenting, via the graphical user interface, a representation of physical couplings between the selected motor control system component of the first type, the selected motor control system component of the second type, and the selected motor system component of the third type.

20. A non-transitory computer-readable medium having contents that configure a processing device to perform a method, the method comprising:
presenting, via a graphical user interface, a first list of types of motor control system components, the first list of types of motor control system components including motors and a plurality of system board types;
receiving, via the graphical user interface, a first selection of a first type of motor control system component from the first list of types of motor control system components;
in response to the first selection of a first type of motor control system component from the first list of types of motor control system components:
presenting, via the graphical user interface, a second list of motor control system components of the first type;
receiving, via the graphical user interface, a second selection of a motor control system component of the first type from the second list of motor control system components of the first type; and
in response to the second selection of the motor control system component of the first type:
presenting, via the graphical user interface, a third list of motor control system components of a second type different from the first type;
receiving, via the graphical user interface, a third selection of a motor control system component of the second type from the third list of motor control system components of the second type; and
in response to the third selection of the motor control system component of the second type, presenting, via the graphical user interface, a representation of a physical coupling between the selected motor control system component of the first type and the selected motor control system component of the second type;
generating configuration settings for a configurable motor control system component based on the selected motor control system component of the first type and the selected motor control system component of the second type;
generating content for the configurable motor control system component based on the configuration settings; and
providing the generated content to the configurable motor control system component.

21. The non-transitory computer-readable medium of claim 20, wherein the contents of the computer-readable medium comprise instructions executable by the processing device.

22. The non-transitory computer-readable medium of claim 20, wherein the contents of the computer-readable medium comprise configuration option information associated with the configurable motor system component.

23. A computing device, comprising:
a display device;
a memory, which, in operation, stores computer instructions; and
at least one processor, which, in operation, executes the computer instructions to:
present, via a graphical user interface, a first list of types of motor control system components, the first list of types of motor control system components including motors and a plurality of system board types;
receive, via the graphical user interface, a first selection of a first type of motor control system component from the first list of types of motor control system components;
in response to the first selection of a first type of motor control system component from the first list of types of motor control system components:
present, via the graphical user interface, a second list of motor control system components of the first type;
receive, via the graphical user interface, a second selection of a motor control system component of the first type from the second list of motor control system components of the first type; and
in response to the second selection of the motor control system component of the first type:
present, via the graphical user interface, a third list of motor control system components of a second type different from the first type;
receive, via the graphical user interface, a third selection of a motor control system component of the second type from the third list of motor control system components of the second type; and
in response to the third selection of the motor control system component of the second type, present, via the graphical user interface, a representation of a physical coupling between the selected motor control system component of the first type and the selected motor control system component of the second type;
generate configuration settings for a configurable motor control system component based on the selected motor control system component of the first type and the selected motor control system component of the second type;
generate content for the configurable motor control system component based on the configuration settings; and
provide the content to the configurable motor control system component.

24. The device of claim 23, wherein the presenting, via the graphical user interface, a second list of motor control system components of the first type includes presenting a representation of physical, logical or physical and logical characteristics of components of the list of components of the first type.

25. The device of claim 23, wherein the presenting, via the graphical user interface, a third list of motor control system components of a second type different from the first type includes identifying motor control system components of the second type that are compatible with the selected motor control system component of the first type.

26. The device of claim 25 wherein the identifying includes verifying a logical and physical compatibility of the motor control system components of the second type with the selected motor control system component of the first type.
